(19) United States
(12) Patent Application Publication
(10) Pub. No.: US 2019/0236453 A1
(43) Pub. Date: Aug. 1, 2019

(54) METHOD AND SYSTEM FOR DATA TRANSMISSION, AND ELECTRONIC DEVICE

(71) Applicant: BEIJING SENSETIME TECHNOLOGY DEVELOPMENT CO., LTD., Beijing (CN)

(72) Inventors: Yuanhao ZHU, Beijing (CN); Shengen YAN, Beijing (CN)

(73) Assignee: BEIJING SENSETIME TECHNOLOGY DEVELOPMENT CO., LTD., Beijing (CN)

(21) Appl. No.: 16/382,058

(22) Filed: Apr. 11, 2019

Related U.S. Application Data
(63) Continuation of application No. PCT/CN2017/108450, filed on Oct. 30, 2017.

(30) Foreign Application Priority Data
Oct. 28, 2016 (CN) 201610972729.4

(51) Int. Cl. G06N 3/08; G06N 3/04; G06K 9/62

(52) U.S. Cl. CPC G06N 3/08; G06K 9/6218; G06K 9/6249; G06N 3/0454

(57) ABSTRACT

A method for data transmission includes: determining first data to be sent by a node in a distributed system to at least one other node and configured to perform parameter update on a deep learning model trained by the distributed system; performing sparse processing on at least some data in the first data; and sending the at least some data on which sparse processing is performed in the first data to the at least one other node. A system for data transmission and an electronic device are also provided.

### CROSS-REFERENCE TO RELATED APPLICATIONS

The present application is a continuation of International Application No. PCT/CN2017/108450 filed on Oct. 30, 2017, which claims priority to Chinese Patent Application No. CN 201610972729.4 filed on Oct. 28, 2016, the contents of which are hereby incorporated by reference in its entirety.

### BACKGROUND

With the advent of the era of big data, deep learning has been widely used, including in image recognition, recommendation systems, and natural language processing, etc. A deep learning training system is a computing system that acquires a deep learning model by training input data. In an industrial environment, in order to provide a high-quality deep learning model, the deep learning training system needs to process a large amount of training data. For example, the ImageNet dataset opened by the Stanford Computer Vision Lab contains more than 14 million high-precision images. However, a single-node deep learning training system often take weeks or even months to complete operations due to its computational capacity and memory limits. In such circumstances, a distributed deep learning training system has received extensive attention in industry and academia.

### SUMMARY

The present disclosure relates to deep learning techniques, and in particular, to a method for data transmission, a system for data transmission and an electronic device.

Embodiments of the present disclosure provide data transmission solutions. According to a first aspect of the embodiments of the present disclosure, there is provided a method for data transmission, including: determining first data which is to be sent by a node in a distributed system to at least one other node and is configured to perform parameter update on a deep learning model trained by the distributed system; performing sparse processing on at least some data in the first data; and sending the at least some data on which sparse processing is performed in the first data to the at least one other node.

According to a second aspect of the embodiments of the disclosure, there is provided a system for data transmission, including: a memory storing processor-executable instructions; and a processor arranged to execute the stored processor-executable instructions to perform steps of: determining first data which is to be sent by a node in a distributed system to at least one other node and is configured to perform parameter update on a deep learning model trained by the distributed system; performing sparse processing on at least some data in the first data; and sending the at least some data on which sparse processing is performed in the first data to the at least one other node.

According to a third aspect of the embodiment of the disclosure, there is provided a non-transitory computer-readable storage medium having stored thereon computer-readable instructions that, when executed by a processor, cause the processor to execute a method for data transmission, the method including: determining first data which is to be sent by a node in a distributed system to at least one other node and is configured to perform parameter update on a deep learning model trained by the distributed system; performing sparse processing on at least some data in the first data; and sending the at least some data on which sparse processing is performed in the first data to the at least one other node.

The following further describes in detail the technical solutions of the present disclosure with reference to the accompanying drawings and embodiments.

### BRIEF DESCRIPTION OF DRAWINGS

The accompanying drawings constituting a part of the specification are used for describing embodiments of the present disclosure and are intended to explain the principles of the present disclosure together with the descriptions.

The present disclosure will be described below with reference to the accompanying drawings in conjunction with optional embodiments.

FIG. 1 is a flowchart of an embodiment of a method for data transmission according to the present disclosure;

FIG. 2 is an exemplary flowchart of gradient filtering in an embodiment of the method for data transmission according to the present disclosure;

FIG. 3 is an exemplary flowchart of parameter filtering in an embodiment of the method for data transmission according to the present disclosure;

FIG. 4 is a schematic structural diagram of an embodiment of a system for data transmission according to the present disclosure;

FIG. 5 is a schematic structural diagram of another embodiment of the system for data transmission according to the present disclosure;

FIG. 6 is a schematic structural diagram of an embodiment of an electronic device of the present disclosure; and

FIG. 7 is a schematic structural diagram of an embodiment of an electronic device of the present disclosure.

For the sake of clarity, the accompanying drawings are schematic and simplified, and only details necessary for understanding the present disclosure are given, and other details are omitted.

### DETAILED DESCRIPTION

Various exemplary embodiments of the present disclosure are now described in detail with reference to the accompanying drawings. It should be understood that the detailed description and specific examples, while indicating optional embodiments of the present invention, are given for the purpose of illustration only. It should be noted that, unless otherwise stated specifically, relative arrangement of the components and steps, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to persons of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

Embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems, and the like.

The electronic devices such as terminal devices, computer systems, and servers may be described in the general context of computer system executable instructions (such as, program modules) executed by the computer system. Generally, the program modules may include routines, programs, target programs, assemblies, logics, data structures, and the like, to perform specific tasks or implement specific abstract data types. The computer systems/servers may be practiced in the distributed cloud computing environments in which tasks are executed by remote processing devices that are linked through a communications network. In the distributed computing environments, the program modules may be located in local or remote computing system storage media including storage devices.

The inventors of the present disclosure have recognized that, a typical distributed deep learning training system generally employs a distributed computing framework to run a gradient descent algorithm. In each iterative computation, the network traffic generated by gradient aggregation, parameter broadcast, and the like is generally in direct proportion to the size of the deep learning model. Moreover, novel deep learning models are growing in size. For example, an AlexNet model contains more than 60 million parameters, and a VGG-16 model contains hundreds of millions of parameters. Therefore, an enormous amount of network traffic would be generated during deep learning training. Due to network bandwidth and other limitations, communication time becomes one of the performance bottlenecks of the distributed deep learning training system.

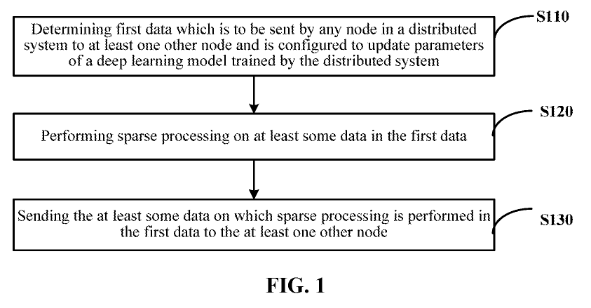

FIG. 1 is a flowchart of an embodiment of a method for data transmission according to the present disclosure. As shown in FIG. 1, the method for data transmission according to this embodiment includes: In step S110, first data which is to be sent by a node in a distributed system to at least one other node and is configured to perform parameter update on a deep learning model trained by the distributed system is determined.

The distributed system here is, for example, a cluster consisting of multiple computing nodes, or may consist of multiple computing nodes and a parameter server. The deep learning model here may include, for example, but is not limited to, a neural network (such as a convolutional neural network). The parameters here are, for example, matrix variables for constructing the deep learning model, and the like.

In an optional example, step S110 is executed by a processor by invoking a corresponding instruction stored in a memory, and is also executed by a data determining module run by the processor.

In step S120, sparse processing is performed on at least some data in the first data.

In various embodiments of the present disclosure, the purpose of sparse processing is to remove less important data from the first data, thereby reducing network traffic consumed by transmitting the first data and reducing the training time for the deep learning model.

In an optional example, step S120 is executed by a processor by invoking a corresponding instruction stored in a memory, and is also executed by a sparse processing module run by the processor.

In step S130, the at least some data on which sparse processing is performed in the first data is sent to the at least one other node.

In an optional example, step S130 is executed by a processor by invoking a corresponding instruction stored in a memory, and is also executed by a data sending module run by the processor.

The method for data transmission according to the embodiments of the present disclosure is used for transmitting, between any two computing nodes or between a computing node and a parameter server in a distributed deep learning system, data configured to perform parameter update on a deep learning model running on a computing node. Less important data, such as unimportant gradients and/or parameters, in the transmitted data can be ignored, so as to reduce network traffic generated during aggregation and broadcast operations, thereby reducing the time for network transmission in each iterative computation, and shortening the overall deep learning training time.

In an optional embodiment, the performing sparse processing on at least some data in the first data includes: comparing the at least some data in the first data with a given filtering threshold separately, and filtering out data less than the filtering threshold from the compared at least some data in the first data.

The filtering threshold may decrease as the number of training iterations of the deep learning model increases, so that small parameters are less likely to be selected for removal later in the training.

In an optional embodiment, before the performing sparse processing on at least some data in the first data, the method further includes: randomly determining some of the first data as the at least some data; and performing sparse processing on the determined at least some data in the first data. In other words, here sparse processing is performed on some data in the first data, and the remaining data in the first data is not subjected to sparse processing. The data that is not subjected to sparse processing is sent in a conventional manner. In an optional example, the steps are executed by a processor by invoking a corresponding instruction stored in a memory, and are also executed by a data acquiring module run by the processor, for example, respectively executed by a random selecting sub-module and a sparse sub-module in the data acquiring module run by the processor.

In an optional embodiment, the sending the at least some data on which sparse processing is performed in the first data to the at least one other node includes: compressing the at least some data on which sparse processing is performed in the first data, where a general compression algorithm, such as snappy and zlib compression algorithms, is used for the compressing; and sending the compressed first data to the at least one other node. In an optional example, the steps are executed by a processor by invoking a corresponding instruction stored in a memory, and are also executed by a data sending module run by the processor, for example, respectively executed by a compressing sub-module and a sending sub-module in the data sending module run by the processor.

In another implementation of the method for data transmission of the present disclosure, the method further includes:

acquiring, by any of the foregoing nodes, second data which is sent by the at least one other node and is configured to perform parameter update on the deep learning model trained by the distributed system, for example, receiving and decompressing the second data which is sent by the at least one other node after compression and is configured to perform parameter update on the deep learning model trained by the distributed system, where in an optional example, the step is executed by a processor by invoking a corresponding instruction stored in a memory, and is also executed by a data acquiring module run by the processor; and

updating the parameters of the deep learning model at least according to the second data. The updating may occur on any of the foregoing nodes when the current round of training is completed during iterative training of the deep learning model. In an optional example, the step is executed by a processor by invoking a corresponding instruction stored in a memory, and is also executed by an updating module run by the processor.

In an optional embodiment, the first data includes: a gradient matrix calculated by any of the foregoing nodes on the basis of any training process during iterative training of the deep learning model. The distributed deep learning training system provides original gradient values (including gradient values generated by all computing nodes) as inputs. The input gradients are a matrix consisting of single-precision values and are matrix variables configured to update parameters of the deep learning model. And/or, in another optional embodiment, the first data includes: a parameter difference matrix, on any of the foregoing nodes, between old parameters of any training during iterative training of the deep learning model and new parameters obtained by updating the old parameters at least according to the second data which is sent by the at least one other node and is configured to perform parameter update on the deep learning model trained by the distributed system. In each parameter broadcast operation, the distributed deep learning training system replaces parameters cached by each computing node with newly updated parameters. The parameters refer to matrix variables that construct the deep learning model, and are a matrix consisting of single-precision values.

In an optional example of various embodiments of the present disclosure, if the first data includes the gradient matrix, the performing sparse processing on at least some data in the first data includes: selecting, from the gradient matrix, a first portion of matrix elements with absolute values separately less than the filtering threshold; randomly selecting a second portion of matrix elements from the gradient matrix; and setting values of matrix elements in the gradient matrix which are in both the first portion of matrix elements and the second portion of matrix elements to 0, to obtain a sparse gradient matrix. Accordingly, in this example, the sending the at least some data on which sparse processing is performed in the first data to the at least one other node may include: compressing the sparse gradient matrix into a string; and sending the string to the at least one other node through a network.

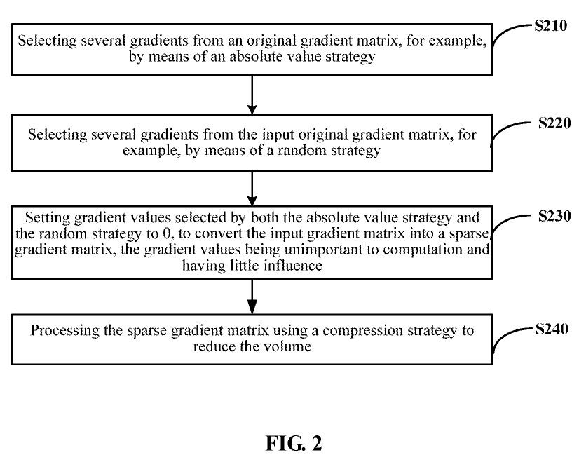

FIG. 2 is an exemplary flowchart of gradient filtering in an embodiment of the method for data transmission according to the present disclosure. As shown in FIG. 2, the embodiment includes:

in step S210, several gradients are selected from an original gradient matrix, for example, by means of an absolute value strategy.

The absolute value strategy is used to select gradients with absolute values less than a given filtering threshold. The filtering threshold is exemplarily calculated by the following formula:

$$\frac{φ gsmp}{1 + dgsmp \times log ( t )} ,$$

where ϕ_{gsmp} represents an initial filtering threshold, which can be preset before deep learning training, and dgsmp is also a preset constant. In a deep learning training system, the number of iterations required is pre-specified, and t represents the current number of iterations in deep learning training. The filtering threshold is dynamically changed by dgsmp×log(t) as the number of iterations increases. The filtering threshold becomes less and less as the number of iterations increases. Thus, small gradients are less likely to be selected for removal later in the training. In this embodiment, the value of ϕgsmp is between 1×10⁻⁴ and 1×10⁻³, and the value of dgsmp is between 0.1 and 1. The specific values may be adjusted according to the specific application.

In step S220, several gradients are selected from the input original gradient matrix, for example, by means of a random strategy.

The random strategy is used to randomly select a given ratio among all the gradient values input, for example, a gradient of 50%-90%, 60%-80%, and the like.

In an optional example, steps S210 and S220 are executed by a processor by invoking a corresponding instruction stored in a memory, and are also executed by a sparse processing module run by the processor or a random selecting sub-module in the sparse processing module.

In step S230, gradient values selected by both the absolute value strategy and the random strategy are set to 0 to convert the input gradient matrix into a sparse gradient matrix, the gradient values being unimportant to computation and having little influences.

In step S240, the sparse gradient matrix is processed using a compression strategy to reduce the volume.

The sparse gradient matrix is compressed into a string by the compression strategy, for example, using a universal compression algorithm, such as snappy and zlib compression algorithms.

In an optional example, steps S230 and S240 are executed by a processor by invoking a corresponding instruction stored in a memory, and are also executed by a sparse processing module run by the processor or a sparse sub-module in the sparse processing module.

By means of the embodiment shown in FIG. 2, the gradient matrix is subjected to the removal operation of the absolute value strategy and the random strategy and the compression operation of the compression strategy to output a string, thereby greatly reducing the volume. In a gradient accumulation operation, the computing node transmits the generated string through the network, and the network traffic generated by this process is correspondingly reduced, so that the communication time in the gradient accumulation process can be effectively reduced.

In another optional example of various embodiments of the present disclosure, if the first data includes the parameter difference matrix, the performing sparse processing on at least some data in the first data includes: selecting, from the parameter difference matrix, a third portion of matrix elements with absolute values separately less than the filtering threshold; randomly selecting a fourth portion of matrix elements from the parameter difference matrix; and setting values of matrix elements in the parameter difference matrix which are in both the third portion of matrix elements and the fourth portion of matrix elements to 0, to obtain a sparse parameter difference matrix. Accordingly, in this example, the sending the at least some data on which sparse processing is performed in the first data to the at least one other node may include: compressing the sparse parameter difference matrix into a string; and sending the string to the at least one other node through a network.

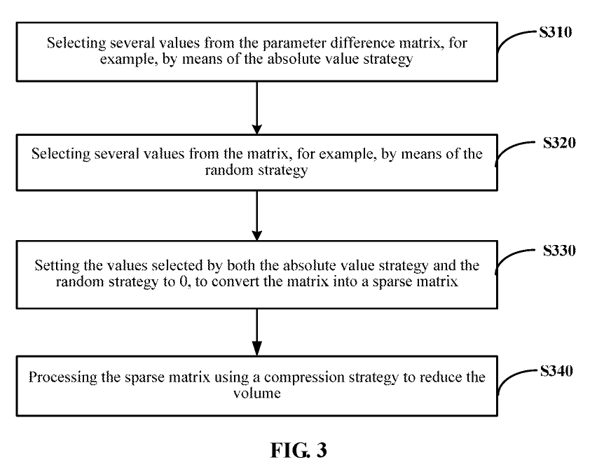

FIG. 3 is an exemplary flowchart of parameter filtering in an embodiment of the method for data transmission according to the present disclosure. In this embodiment, newly updated parameters in the deep learning model are represented by θnew, and cached old parameters are represented by θold. The parameter difference matrix is expressed as: θdiff−θnew−θold, and is a matrix consisting of the same number of new parameters and old parameters. As shown in FIG. 3, the embodiment includes:

in step S310, several values are selected from the parameter difference matrix θdiff, for example, by means of the absolute value strategy.

The absolute value strategy is used to select gradients with absolute values less than the given filtering threshold. The filtering threshold is exemplarily calculated by the following formula:

$$\frac{φ gsmp}{1 + dgsmp \times log ( t )} ,$$

where ϕgsmp represents an initial filtering threshold, which can be preset before deep learning training, and dgsmp is also a preset constant. In a deep learning training system, the number of iterations required is pre-specified, and t represents the current number of iterations in deep learning training. The filtering threshold is dynamically changed by dgsmp×log(t) as the number of iterations increases. The filtering threshold becomes less and less as the number of iterations increases. Thus, small gradients are less likely to be selected for removal later in the training. In this embodiment, the value of ϕgsmp is between 1×10⁻⁴ and 1×10⁻³, and the value of dgsmp is between 0.1 and 1. The specific values may be adjusted according to the specific application.

In step S320, several values are selected from the θdiff matrix, for example, by means of the random strategy.

The random strategy is used to randomly select a given ratio among the entire θdiff matrix input, for example, a gradient of 50%-90%, 60%-80%, and the like.

In an optional example, steps S310 and S320 are executed by a processor by invoking a corresponding instruction stored in a memory, and are also executed by a sparse processing module run by the processor or a random selecting sub-module in the sparse processing module.

In step S330, the θdiff values selected by both the absolute value strategy and the random strategy are set to 0 to convert the θdiff matrix into a sparse matrix.

In step S340, the sparse matrix is processed using a compression strategy to reduce the volume.

The sparse matrix is compressed into a string by the compression strategy, for example, using a universal compression algorithm, such as snappy and zlib compression algorithms.

In an optional example, steps S330 and S340 are executed by a processor by invoking a corresponding instruction stored in a memory, and are also executed by a sparse processing module run by the processor or a sparse sub-module in the sparse processing module.

The deep learning training system broadcasts the generated string through the network, greatly reducing the network traffic generated in the parameter broadcast operation. Therefore, the communication time can be effectively reduced, thereby reducing the overall deep learning training time. The computing node acquires the string, then decompresses the string, and adds θdiff and the cached θold to update corresponding parameters.

In an optional embodiment, the same node may use the gradient filtering mode shown in FIG. 2, and may also use the parameter filtering mode shown in FIG. 3, and the corresponding steps are not described herein again.

Any method for data transmission provided in the embodiments of the present disclosure is executed by any appropriate device having data processing capability, including, but not limited to, a terminal device and a server, etc. Alternatively, any method for data transmission provided in the embodiments of the present disclosure is executed by a processor, for example, any method for data transmission mentioned in the embodiments of the present disclosure is executed by the processor by invoking a corresponding instruction stored in a memory. Details are not described below again.

Persons of ordinary skill in the art may understand that all or some steps for implementing the foregoing method embodiments are achieved by a program by instructing related hardware; the foregoing program can be stored in a computer readable storage medium; when the program is executed, steps including the foregoing method embodiments are executed. Moreover, the foregoing storage medium includes various media capable of storing program codes such as ROM, RAM, a magnetic disk, or an optical disk.

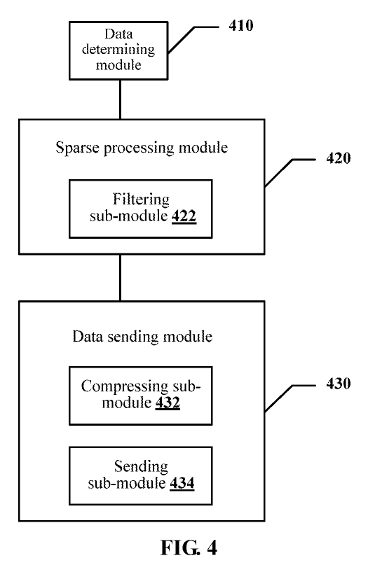

FIG. 4 is a schematic structural diagram of an embodiment of a system for data transmission according to the present disclosure. The data processing system in the embodiments of the present invention is used for implementing the embodiments of the foregoing data processing methods of the present disclosure. As shown in FIG. 4, the system in this embodiment includes:

a data determining module 410, configured to determine first data which is to be sent by any node in a distributed system to at least one other node and is configured to perform parameter update on a deep learning model trained by the distributed system;
a sparse processing module 420, configured to perform sparse processing on at least some data in the first data,

where in an optional implementation of the embodiments of the system for data transmission of the present disclosure, the sparse processing module 420 includes: a filtering sub-module 422, configured to compare the at least some data in the first data with a given filtering threshold separately, and filter out data less than the filtering threshold from the compared at least some data in the first data, where the filtering threshold decreases as the number of training iterations of the deep learning model increases; and

a data sending module 430, configured to send the at least some data on which sparse processing is performed in the first data to the at least one other node.

In still another embodiment of the system for data transmission of the present disclosure, the sparse processing module 420 further includes: a random selecting sub-module, configured to randomly determine some of the first data as the at least some data before performing sparse processing on the at least some data in the first data on the basis of a predetermined strategy; and a sparse sub-module, configured to perform sparse processing on the determined at least some data in the first data.

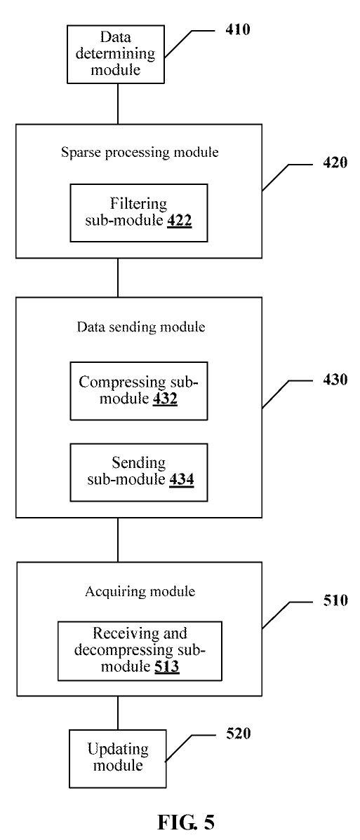

In an optional implementation of the embodiments of the system for data transmission of the present disclosure, the data sending module 430 includes: a compressing sub-module 432, configured to compress the at least some data on which sparse processing is performed in the first data; and a sending sub-module 434, configured to send the compressed first data to the at least one other node. FIG. 5 is a schematic structural diagram of another embodiment of a system for data transmission according to the present disclosure. As shown in FIG. 5, compared with the embodiment shown in FIG. 4, the system for data transmission in this embodiment further includes:

a data acquiring module 510, configured to acquire second data which is sent by the at least one other node and is configured to perform parameter update on the deep learning model trained by the distributed system; and

an updating module 520, configured to update the parameters of the deep learning model on the node at least according to the second data.

In an optional implementation of the embodiments of the system for data transmission of the present disclosure, the data acquiring module 510 includes: a receiving and decompressing sub-module 512, configured to receive and decompress the second data which is sent by the at least one other node after compression and is configured to perform parameter update on the deep learning model trained by the distributed system.

In an optional implementation, the first data includes: a gradient matrix calculated by any of the foregoing nodes on the basis of any training process during iterative training of the deep learning model; and/or a parameter difference matrix, on any of the foregoing nodes, between old parameters of any training during iterative training of the deep learning model and new parameters obtained by updating the old parameters at least according to the second data which is sent by the at least one other node and is configured to perform parameter update on the deep learning model trained by the distributed system.

If the first data includes the gradient matrix, the filtering sub-module 422 is configured to select, from the gradient matrix, a first portion of matrix elements with absolute values separately less than the given filtering threshold; the random selecting sub-module is configured to randomly select a second portion of matrix elements from the gradient matrix; the sparse sub-module is configured to set values of matrix elements in the gradient matrix which are in both the first portion of matrix elements and the second portion of matrix elements to 0, to obtain a sparse gradient matrix; the compressing sub-module is configured to compress the sparse gradient matrix into a string; and the sending sub-module is configured to send the string to the at least one other node through a network.

If the first data includes the parameter difference matrix, the filtering sub-module is configured to select, from the parameter difference matrix, a third portion of matrix elements with absolute values separately less than the given filtering threshold; the random selecting sub-module is configured to randomly select a fourth portion of matrix elements from the parameter difference matrix; the sparse sub-module is configured to set values of matrix elements in the parameter difference matrix which are in both the third portion of matrix elements and the fourth portion of matrix elements to 0, to obtain a sparse parameter difference matrix; the compressing sub-module is configured to compress the sparse parameter difference matrix into a string; and the sending sub-module is configured to send the string to the at least one other node through the network.

The embodiments of the present disclosure further provide an electronic device, including the data processing system according to any of the foregoing embodiments of the present disclosure.

The embodiments of the present disclosure further provide another electronic device, including:

a processor and the system for data transmission according to any of the foregoing embodiments of the present disclosure,

where when the processor runs the system for data transmission, units in the system for data transmission according to any of the foregoing embodiments of the present disclosure are run.

The embodiments of the present disclosure further provide still another electronic device, including: one or more processors, a memory, multiple cache elements, a communication component, and a communication bus, where the processor, the memory, the multiple cache elements, and the communication component communicate with one another by means of the communication bus, the multiple cache elements have different transmission rates and/or storage spaces, and different search priorities are preset for the multiple cache elements according to the transmission rates and/or the storage spaces.

The memory is configured to store at least one executable instruction, and the executable instruction causes the processor to execute corresponding operations of the method for data transmission according to any of the foregoing embodiments of the present disclosure.

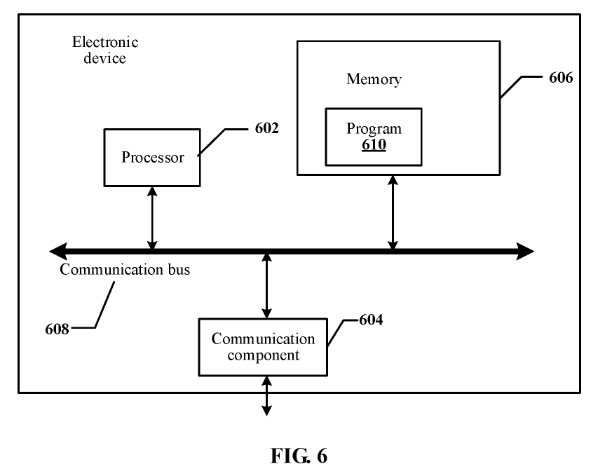

FIG. 6 is a schematic structural diagram of an embodiment of an electronic device of the present disclosure. The device includes: a processor 602, a communication component 604, a memory 606, and a communication bus 608. The communication component may include, but is not limited to, an Input/Output (I/O) interface, a network card, and the like.

The processor 602, the communication component 604, and the memory 606 communicate with one another by means of the communication bus 608.

The communication component 604 is configured to communicate with network elements of other devices, such as a client or a data acquiring device.

The processor 602 is configured to execute a program 610, and may specifically execute related steps in the foregoing method embodiments.

Specifically, the program may include a program code that includes computer operating instructions.

There are one or more processors 602, and the processor is in the form of a Central Processing Unit (CPU), or an Application Specific Integrated Circuit (ASIC), or one or more integrated circuits configured to implement the embodiments of the present disclosure, or the like.

The memory 606 is configured to store the program 610. The memory 606 may include a high-speed Random Access Memory (RAM), and may also further include a non-volatile memory, such as at least one disk memory.

The program 610 includes at least one executable instruction, which is specifically used for causing the processor 602 to execute the following operations: determining first data which is to be sent by any node in a distributed system to at least one other node and is configured to perform parameter update on a deep learning model trained by the distributed system; performing sparse processing on at least some data in the first data; and sending the at least some data on which sparse processing is performed in the first data to the at least one other node.

For specific implementation of the steps in the program 610, reference is made to corresponding descriptions in the corresponding steps and units in the foregoing embodiments, and details are not described herein again. Persons skilled in the art can clearly understand that for convenience and brevity of description, reference is made to corresponding process descriptions in the foregoing method embodiments for the specific working processes of the devices and the modules described above, and details are not described herein again.

According to the method and the system for data transmission, the electronic devices, the programs, and the media provided by the embodiments of the present disclosure, first data which is to be sent by any node in a distributed system to at least one other node and is configured to perform parameter update on a deep learning model trained by the distributed system is determined; sparse processing is performed on at least some data in the first data; and the at least some data on which sparse processing is performed in the first data is sent to the at least one other node. By means of the embodiments of the present disclosure, at least some unimportant data (such as gradients and/or parameters) can be removed, network traffic generated by each gradient accumulation and/or parameter broadcast can be reduced, and training time can be shortened. By means of the present disclosure, the latest parameters may be acquired in time without reducing the communication frequency. The present disclosure may be used in a deep learning training system requiring communication in each iteration, and may also be used in a system the communication frequency of which needs to be reduced.

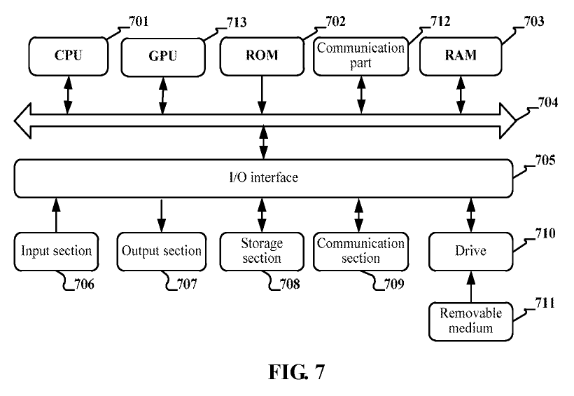

FIG. 7 is a schematic structural diagram of an embodiment of an electronic device of the present disclosure. Referring to FIG. 7 below, a schematic structural diagram of an electronic device suitable for implementing a terminal device or a server according to the embodiments of the present disclosure is shown. As shown in FIG. 7, the electronic device includes one or more processors, a communication part, and the like. The one or more processors are, for example, one or more CPUs 702, and/or one or more Graphic Processing Units (GPUs) 713, and the like. The processor may execute various appropriate actions and processing according to executable instructions stored in a Read-Only Memory (ROM) 702 or executable instructions loaded from a storage section 708 to a RAM 703. The communication part 712 may include, but is not limited to, a network card, which may include, but is not limited to, an Infiniband (IB) network card, and the processor may communicate with the ROM 702 and/or the RAM 703 to execute executable instructions, is connected to the communication part 712 through the bus 704, and communicates with other target devices via the communication part 712, thereby completing operations corresponding to any data processing method provided by the embodiments of the present disclosure, for example, determining first data which is to be sent by any node in a distributed system to at least one other node and is configured to perform parameter update on a deep learning model trained by the distributed system, performing sparse processing on at least some data in the first data, and sending the at least some data on which sparse processing is performed in the first data to the at least one other node.

In addition, the RAM 703 may further store various programs and data required for operations of an apparatus. The CPU 701, the ROM 702, and the RAM 703 are connected to each other via the bus 704. In the presence of the RAM 703, the ROM 702 is an optional module. The RAM 703 stores executable instructions, or writes the executable instructions to the ROM 702 during running. The executable instructions cause the processor 701 to execute corresponding operations of the foregoing data processing method. An I/O interface 705 is also connected to the bus 704. The communication part 712 is integrated, or is configured to have multiple sub-modules (for example, multiple IB network cards) connected to the bus.

The following components are connected to the I/O interface 705: an input section 706 including a keyboard, a mouse and the like; an output section 707 including a Cathode-Ray Tube (CRT), a Liquid Crystal Display (LCD), a speaker and the like; the storage section 708 including a hard disk and the like; and a communication section 709 of a network interface card including an LAN card, a modem and the like. The communication section 709 performs communication processing via a network such as the Internet. A drive 710 is also connected to the I/O interface 705 according to needs. A removable medium 711 such as a magnetic disk, an optical disk, a magneto-optical disk, a semiconductor memory or the like is mounted on the drive 710 according to needs, so that a computer program read from the removable medium 711 is installed on the storage section 708 according to needs.

It should be noted that the architecture shown in FIG. 7 is merely an optional implementation. During specific practice, the number and types of the components in FIG. 7 is selected, decreased, increased, or replaced according to actual requirements. Different functional components are separated or integrated or the like. For example, the GPU and the CPU are separated, or the GPU is integrated on the CPU, and the communication part is separated from or integrated on the CPU or the GPU or the like. These alternative implementations all fall within the scope of protection of the present disclosure.

Particularly, a process described above with reference to a flowchart according to the embodiments of this disclosure is implemented as a computer software program. For example, the embodiments of the present disclosure include a computer program product, which includes a computer program tangibly included in a machine-readable medium. The computer program includes a program code for executing a method shown in the flowchart. The program code may include corresponding instructions for correspondingly executing steps of the methods provided by the embodiments of the present disclosure, for example, an instruction for determining first data which is to be sent by any node in a distributed system to at least one other node and is configured to perform parameter update on a deep learning model trained by the distributed system, an instruction for performing sparse processing on at least some data in the first data, and an instruction for sending the at least some data on which sparse processing is performed in the first data to the at least one other node.

In addition, the embodiments of the present disclosure further provide a computer program, including a computer-readable code, where when the computer-readable code runs in a device, a processor in the device executes instructions for implementing the steps of the method for data transmission according to any one of the embodiments of the present disclosure.

In addition, the embodiments of the present disclosure further provide a computer-readable storage medium configured to store computer-readable instructions, where when the instructions are executed, the operations in the steps of the method for data transmission according to any one of the embodiments of the present disclosure are implemented.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments. As used herein, the singular forms “a”, “an”, and “the” are intended to include the plural forms as well (i.e., to have the meaning “at least one”), unless expressly stated otherwise. It will be further understood that the terms “have”, “include”, and/or “comprise”, when used in this specification, specify the presence of stated features, steps, operations, elements, and/or components, but do not preclude the presence or addition of one or more other features, steps, operations, elements, components, and/or combinations thereof. As used herein, the term “and/or” includes any and all combinations of one or more of the associated listed items. The steps of any method disclosed herein do not have to be performed in the exact order disclosed, unless expressly stated otherwise.

While some optional embodiments have been described above, it should be emphasized that the present disclosure is not limited to the embodiments, but is implemented in other ways within the scope of the subject matter of the present disclosure.

It should be noted that according to needs for implementation, the components/steps described in the embodiments of the present disclosure are separated into more components/steps, and two or more components/steps or some operations of the components/steps are also combined into new components/steps to achieve the purpose of the embodiments of the present disclosure.

The foregoing methods according to the embodiments of the present disclosure are implemented in hardware or firmware, or implemented as software or computer codes stored in a recording medium (such as a CD ROM, a RAM, a floppy disk, a hard disk, or a magneto-optical disk), or implemented as computer codes that can be downloaded through a network and are originally stored in a remote recording medium or a non-volatile machine-readable medium and are stored in a local recording medium; accordingly, the methods described herein are handled by software stored in a recording medium using a general-purpose computer, a special-purpose processor, or programmable or dedicated hardware (such as ASIC or FPGA). As can be understood, a computer, a processor, a microprocessor controller or programmable hardware includes a storage component (e.g., RAM, ROM, flash memory, etc.) that can store or receive software or computer codes, when the software or computer codes are accessed and executed by the computer, processor or hardware, the processing method described herein is carried out. In addition, when a general-purpose computer accesses codes that implement the processes shown herein, the execution of the codes converts the general-purpose computer to a special-purpose computer for executing the processes shown herein.

Persons of ordinary skill in the art can understand that the individual exemplary units and method steps that are described in conjunction with the embodiments disclosed herein can be implemented in electronic hardware, or a combination of computer software and electronic hardware. Implementing these functions in hardware or software depends on the optional applications and design constraint conditions of the technical solution. For each optional application, the described functions can be implemented by persons skilled in the art using different methods, but such implementation should not be considered to go beyond the scope of the embodiments of the present disclosure.

The above implementations are merely for describing the embodiments of the present disclosure, and are not intended to limit the embodiments of the present disclosure. Persons of ordinary skill in the art may make various variations and modifications without departing from the spirit and scope of the embodiments of the present disclosure. Therefore, all equivalent technical solutions also fall within the scope of the embodiments of the present disclosure, and the patent protection scope of the embodiments of the present disclosure shall be limited by the claims.

1. A method for data transmission, comprising:
determining first data to be sent by a node in a distributed system to at least one other node and configured to perform parameter update on a deep learning model trained by the distributed system;
performing sparse processing on at least some data in the first data; and
sending the at least some data on which sparse processing is performed in the first data to the at least one other node.

2. The method according to claim 1, wherein the performing sparse processing on at least some data in the first data comprises:
comparing the at least some data in the first data with a given filtering threshold separately, and filtering out data less than the filtering threshold from the at least some data, wherein the filtering threshold decreases as the number of training iterations of the deep learning model increases.

3. The method according to claim 1, wherein before the performing sparse processing on at least some data in the first data, the method further comprises:
randomly determining some of the first data as the at least some data; and
performing sparse processing on the determined at least some data in the first data.

4. The method according to claim 1, wherein the sending the at least some data on which sparse processing is performed in the first data to the at least one other node comprises:
compressing the at least some data on which sparse processing is performed in the first data; and
sending the compressed first data to the at least one other node.

5. The method according to claim 1, further comprising:
acquiring second data which is sent by the at least one other node and is configured to perform parameter update on the deep learning model trained by the distributed system; and
updating the parameters of the deep learning model at least according to the second data.

6. The method according to claim 5, wherein the acquiring second data which is sent by the at least one other node and is configured to perform parameter update on the deep learning model trained by the distributed system comprises:
receiving and decompressing the second data which is sent by the at least one other node after compression and is configured to perform parameter update on the deep learning model trained by the distributed system.

7. The method according to claim 1, wherein the first data comprises at least one of:
a gradient matrix calculated on the basis of any training process during iterative training of the deep learning model; or
a parameter difference matrix between old parameters of any training during iterative training of the deep learning model and new parameters obtained by updating the old parameters at least according to the second data which is sent by the at least one other node and is configured to perform parameter update on the deep learning model trained by the distributed system.

8. The method according to claim 7, wherein when the first data comprises the gradient matrix, the performing sparse processing on at least some data in the first data comprises:
selecting, from the gradient matrix, a first portion of matrix elements with absolute values separately less than the filtering threshold;
randomly selecting a second portion of matrix elements from the gradient matrix; and
setting values of matrix elements in the gradient matrix which are in both the first portion of matrix elements and the second portion of matrix elements to 0, to obtain a sparse gradient matrix;
the sending the at least some data on which sparse processing is performed in the first data to the at least one other node comprises:
compressing the sparse gradient matrix into a string; and
sending the string to the at least one other node through a network.

9. The method according to claim 7, wherein when the first data comprises the parameter difference matrix, the performing sparse processing on at least some data in the first data comprises:
selecting, from the parameter difference matrix, a third portion of matrix elements with absolute values separately less than the filtering threshold;
randomly selecting a fourth portion of matrix elements from the parameter difference matrix; and
setting values of matrix elements in the parameter difference matrix which are in both the third portion of matrix elements and the fourth portion of matrix elements to 0, to obtain a sparse parameter difference matrix;
the sending the at least some data on which sparse processing is performed in the first data to the at least one other node comprises:
compressing the sparse parameter difference matrix into a string; and
sending the string to the at least one other node through the network.

10. A system for data transmission, comprising:
a memory storing processor-executable instructions; and
a processor arranged to execute the stored processor-executable instructions to perform steps of:
determining first data to be sent by a node in a distributed system to at least one other node and configured to perform parameter update on a deep learning model trained by the distributed system;
performing sparse processing on at least some data in the first data; and
sending the at least some data on which sparse processing is performed in the first data to the at least one other node.

11. The system according to claim 10, wherein the performing sparse processing on at least some data in the first data comprises:
comparing the at least some data in the first data with a given filtering threshold separately, and filtering out data less than the filtering threshold from the at least some data, wherein the filtering threshold decreases as the number of training iterations of the deep learning model increases.

12. The system according to claim 10, wherein the processor is arranged to execute the stored processor-executable instructions to further perform steps of:
before the performing sparse processing on at least some data in the first data,
randomly determining some of the first data as the at least some data; and
performing sparse processing on the determined at least some data in the first data.

13. The system according to claim 10, wherein the sending the at least some data on which sparse processing is performed in the first data to the at least one other node comprises:
compressing the at least some data on which sparse processing is performed in the first data; and
sending the compressed first data to the at least one other node.

14. The system according to claim 10, wherein the processor is arranged to execute the stored processor-executable instructions to further perform steps of:
acquiring second data which is sent by the at least one other node and is configured to perform parameter update on the deep learning model trained by the distributed system; and
updating the parameters of the deep learning model at least according to the second data.

15. The system according to claim 14, wherein the acquiring second data which is sent by the at least one other node and is configured to perform parameter update on the deep learning model trained by the distributed system comprises:
receiving and decompressing the second data which is sent by the at least one other node after compression and is configured to perform parameter update on the deep learning model trained by the distributed system.

16. The system according to claim 10, wherein the first data comprises at least one of:
a gradient matrix calculated on the basis of any training process during iterative training of the deep learning model; or
a parameter difference matrix between old parameters of any training during iterative training of the deep learning model and new parameters obtained by updating the old parameters at least according to the second data which is sent by the at least one other node and is configured to perform parameter update on the deep learning model trained by the distributed system.

17. The system according to claim 16, wherein when the first data comprises the gradient matrix, the performing sparse processing on at least some data in the first data comprises:
selecting, from the gradient matrix, a first portion of matrix elements with absolute values separately less than the filtering threshold;
randomly selecting a second portion of matrix elements from the gradient matrix; and
setting values of matrix elements in the gradient matrix which are in both the first portion of matrix elements and the second portion of matrix elements to 0, to obtain a sparse gradient matrix;
the sending the at least some data on which sparse processing is performed in the first data to the at least one other node comprises:
compressing the sparse gradient matrix into a string; and
sending the string to the at least one other node through a network.

18. The system according to claim 16, wherein when the first data comprises the parameter difference matrix, the performing sparse processing on at least some data in the first data comprises:
selecting, from the parameter difference matrix, a third portion of matrix elements with absolute values separately less than the filtering threshold;
randomly selecting a fourth portion of matrix elements from the parameter difference matrix; and
setting values of matrix elements in the parameter difference matrix which are in both the third portion of matrix elements and the fourth portion of matrix elements to 0, to obtain a sparse parameter difference matrix;
the sending the at least some data on which sparse processing is performed in the first data to the at least one other node comprises:
compressing the sparse parameter difference matrix into a string; and
sending the string to the at least one other node through the network.

19. An electronic device, comprising the system for data transmission according to claim 10.

20. A non-transitory computer-readable storage medium having stored thereon computer-readable instructions that, when executed by a processor, cause the processor to execute a method for data transmission, the method comprising:
determining first data to be sent by a node in a distributed system to at least one other node and configured to perform parameter update on a deep learning model trained by the distributed system;
performing sparse processing on at least some data in the first data; and
sending the at least some data on which sparse processing is performed in the first data to the at least one other node.
